(19) United States
(12) Patent Application Publication
(10) Pub. No.: US 2012/0044610 A1
(43) Pub. Date: Feb. 23, 2012

(54) Y-Doped Barium Strontium Titanate For Stoichiometric Thin Film Growth

(75) Inventors: Troy R. Taylor, Santa Barbara, CA (US); Christopher Elsass, Santa Barbara, CA (US)

(73) Assignee: AGILERF, Goleta, CA (US)

(21) Appl. No.: 13/284,831

(22) Filed: Oct. 28, 2011

Related U.S. Application Data
(62) Division of application No. 10/825,042, filed on Apr. 14, 2004, now abandoned.
(60) Provisional application No. 60/463,153, filed on Apr. 14, 2003.

(51) Int. Cl. H01G 5/013; C04B 35/50; B32B 9/04

(52) U.S. Cl. 361/277; 428/697; 501/137

(57) ABSTRACT

Disclosed is a process for generating thin-film barium strontium titanate (“BST”) having a lattice comprised of a plurality of A lattice sites and a B lattice site, in which a yttrium may be found at a location of at least one location of the plurality of A lattice sites or the B lattice site. In one embodiment, the plurality of A lattice sites comprises a location for at least one from a group consisting of barium and strontium. In one embodiment, the B lattice site comprises a location for a titanium. A capacitor having the inventive Y-doped BST dielectric is also disclosed.

### CROSS-REFERENCE TO RELATED APPLICATIONS

This application is a divisional of U.S. patent application Ser. No. 10/825,042, filed Apr. 14, 2004, which claims the benefit of U.S. Provisional Patent Application Ser. No. 60/463,153, filed Apr. 14, 2003. Each application is incorporated by reference in its entirety.

### BACKGROUND OF THE INVENTION

1. Field of the Invention

This invention generally relates to improved dielectric materials, more particularly to the manufacture and use of thin film yttrium-doped barium strontium titanate (hereinafter “Y-doped BST”) as a dielectric material in voltage variable capacitors, and still more particularly to a method for incorporating dopants into an ABO₃ perovskite crystal structure.

2. Description of the Related Art

BST thin films are interesting because of their large field-dependent dielectric permitivity. This property makes BST thin films highly useful, for example as dielectric materials for voltage variable capacitors. BST has a perovskite crystal structure with generic form ABO₃, where A and B represent the 2+ and 4+ cations, respectively.

BST thin films can be fabricated using a variety of methods, including sol-gel processing and physical vapor deposition. FIG. 1 illustrates a prior art method of forming BST films using sol-gels. The process starts with a sol gel film 110 that is dried to create a green body 120. The green body 120 is then sintered or “baked” 130. The resulting material has a more or less solid crystalline structure 140. A problem with this structure 140, however, is that the composition of the crystal structure is often not uniform and that it typically includes many voids. Further, sol-gels provide poor thickness control. Moreover, the green body method is not capable of producing films with a highly uniform thickness and is limited to films having a thickness no less then about 1000 Angstrom (Å).

Composition and stoichiometry are primary factors that determine the properties of BST films, which are characterized by the chemical formula:

Ba₁₋ₓSrₓTi_{1+y}O₃.

For the purpose of this description, composition is defined in BST films as the ratio of Ba to Sr to Titanate and, optionally, the amount of various other dopants and impurities. Stoichiometry is defined as the ratio of Ba and Sr atoms to Ti atoms in the BST material. It is noted that the unit of measure for the composition is referenced in atomic percentages.

The dielectric constant of a BST film can be tailored for a specific temperature range by altering the film's barium to strontium ratio, i.e., its composition. Dielectric leakage can be reduced by altering the stoichiometry of the material, for example by making BST films with excess titanium, e.g., (0.1>y>0.01). Various dopants also may be used to modify the properties of BST ceramics. For instance, substituting a larger cation, such as zirconium, for titanium, can reduce the temperature dependence of the dielectric constant.

A problem with BST thin film development is that the complex perovskite ceramic crystal structure often causes non-stoichiometric film growth. Film stoichiometry can drastically alter the material properties of the dielectric. Stoichiometry is important because of the numerous defect incorporation and compensation methods in complex oxide materials. For example, a defect such as an oxygen vacancy will be charge-balanced by additional charge carriers, i.e., electrons, in the material. This type of defect compensation mechanism introduces carriers that degrade the insulating behavior of the BST material.

Another problem with BST thin-film development is that the use of physical vapor deposition techniques, such as sputtering, complicate stoichiometric film growth because of the mass and pressure dependent scattering angles for barium, strontium, oxygen and titanium. That is, these ions travel from the sputtering target to the deposition substrate at different angles. Thus, for example, the multi-component thin film resulting from the sputtering process will not necessarily reflect the stoichiometry of the sputtering target. Such non-stoichiometric growth results in a dielectric material that may exhibit poor energy quality, poor quality factor, and a low breakdown voltage.

In view of all of the above issues, there is a need for an improved thin film BST material, a process for growing such a material and a resulting capacitor with a dielectric that provides an increase in energy quality, quality factor and breakdown voltage, and which may have voltage-variable properties.

### SUMMARY OF THE INVENTION

The present invention includes a process for doping an ABO₃ film, for example, barium strontium titanate, with yttrium (“Y”). The inventive thin film growth process places yttrium in the perovskite crystal lattice structure at some of either the A or B lattice sites, or both. That is, the yttrium can be incorporated into the perovskite structure at either: (i) an atomic site where barium or strontium atoms are normally located (an A site), or (b) an atomic site where titanate normally would be found (a B site).

In one embodiment, the process for BST thin-film growth in accordance with the present invention includes reducing the pressure in a sputtering chamber containing an insulating substrate and a yttrium-oxide doped BST target, raising the temperature in the chamber, starting a flow of inert gas (e.g., Ar) and oxygen into the chamber and energizing the gas to create a plasma within the chamber between the target material and the substrate. It is noted that in one embodiment, sputtering may cause oxygen to be lost in the transport process. Hence, oxygen may be flowed in to create a reactive sputtering during the deposition.

Using the flow of argon gas as an example, the argon ions forming the plasma bombard the target so that yttrium oxide doped BST target material is transferred to the substrate and a resulting thin film of Y-doped BST grows on the substrate. As previously mentioned, Y atoms comprising the dopant can be incorporated into the BST lattice of the deposited thin film at either the Br or Sr sites (i.e., the A sites), or at the Ti sites (i.e., the B sites).

An advantage of the present invention is that the use of a yttrium oxide doped BST target beneficially allows for promotion of stoichiometric crystal growth on a substrate, thereby eliminating or suppressing defects in the crystal lattice structure. In particular, if a target material does not include a perfect stoichiometric mix of Ba, Sr and Ti, or if the physical vapor deposition process alters the stoichiometry due to the mechanisms discussed above, the yttrium dopant may be incorporated at a location in the resulting thin film material normally occupied by any of these atoms, e.g., at least one of the barium or strontium lattice sites or at a titanate lattice site. Yttrium is a useful dopant for BST because of its size and stable 3+-oxidation state. It is intermediate in size between A and B site ions and can be a donor (Y³⁺:Ba²⁺:Sr²⁺) or acceptor dopant (Y³⁺Ti⁴⁺).

Use of a Y dopant provides yet another benefit. Yttrium oxide doped BST target material optionally allows for yttrium oxide formation at the grain boundaries in the Y-doped BST thin film. It is believed that such oxide formation inhibits current flow along the BST grain boundaries, thus producing an increased film resistivity, lower losses, and less leakage current.

The features and advantages discussed in this specification are not all inclusive and, in particular, many additional features and advantages will be apparent to one of ordinary skill in the art in view of the drawings, specification, and claims.

### BRIEF DESCRIPTION OF THE DRAWINGS

The invention has other advantages and features that will be more readily apparent from the following detailed description and the appended claims, when taken in conjunction with the accompanying drawings, in which:

FIG. 1 is a diagram of a prior art process for thin-film growth.

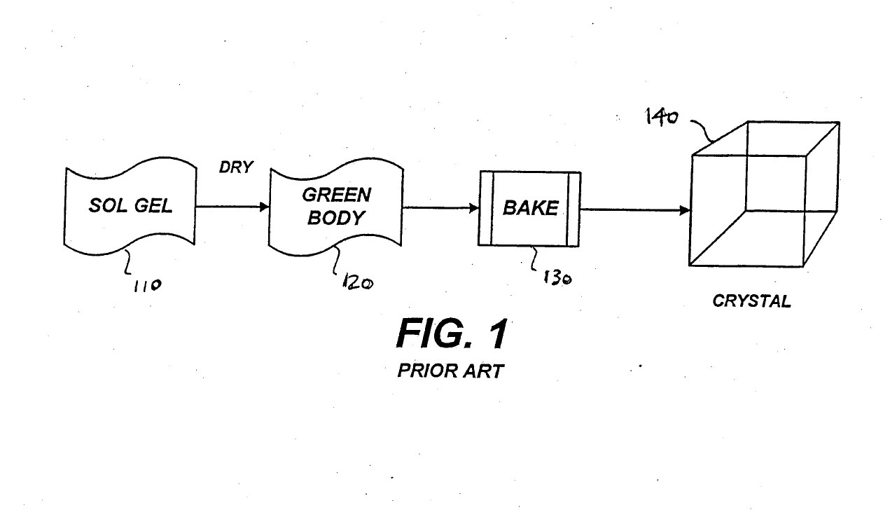

FIG. 2 illustrates an apparatus for thin-film growth in accordance with one embodiment of the present invention.

FIG. 3 illustrates a process diagram for thin-film growth in accordance with one embodiment of the present invention.

FIGS. 4a through 4c illustrate examples of crystal structures for ABO₃ thin-films in accordance with one embodiment of the present invention.

FIGS. 5a through 5c illustrate examples of crystal structures for ABO₃ thin-films grown through use of a Y₂O₃ doped BST target in accordance with one embodiment of the present invention.

### DETAILED DESCRIPTION OF THE PREFERRED EMBODIMENTS

The present invention includes an apparatus and a process for ABO₃ thin-film growth. The present invention also includes devices constructed utilizing the inventive material disclosed herein.

In one embodiment of the present invention, the ABO₃ thin-film is barium strontium titanate. BST has a perovskite crystal structure that may be generically referenced as ABO₃, where A and B represent the 2+ and 4+ cations, respectively. BST thin-films have certain advantages when used with capacitance-type applications because of their large field-dependent dielectric permitivity. Thus, the value of a capacitor utilizing a BST dielectric can be varied with the application of a DC voltage. In addition, dielectric leakage can be improved by having a BST thin film with excess titanium (1% to 10%). It is believed that precipitation of TiO₂ at the BST grain boundaries (like the precipitation of yttrium oxide) helps prevent leakage currents along such grain boundary.

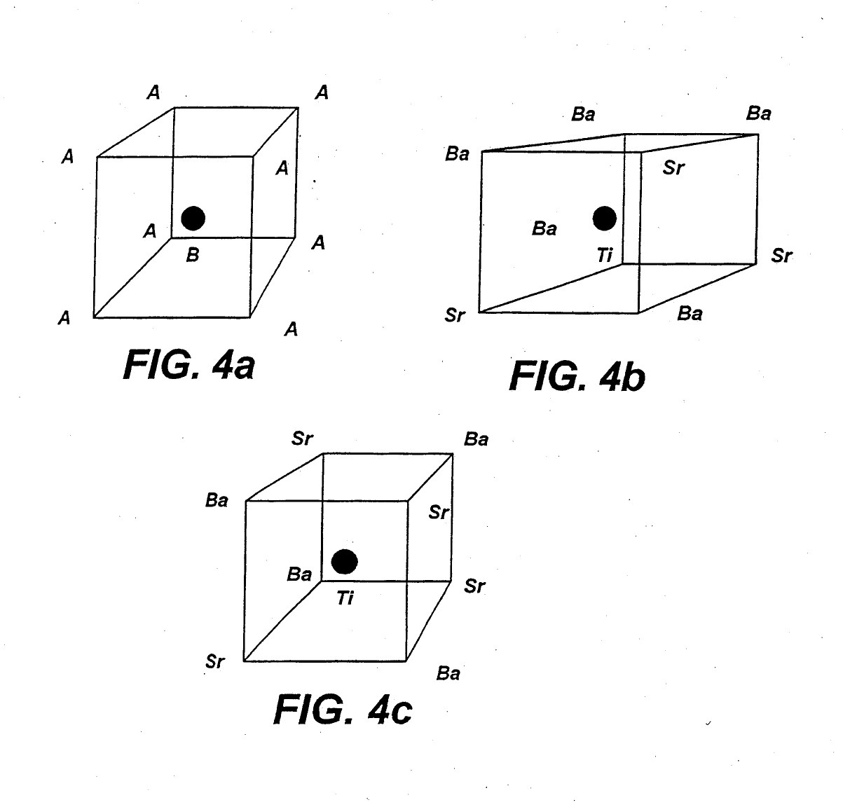

The present invention allows for tailoring the composition and stoichiometry of the BST thin-film, which, in turn, allows for altering the properties of the BST to achieve desired characteristics. FIGS. 4a through 4c illustrate examples of crystal structures for ABO₃ thin-films, such as BST. For example, FIG. 4a illustrates a lattice structure having two or more A lattice sites with a B lattice site located within the structure formed by the A lattice sites. The A lattice sites provide locations for barium or strontium and the B lattice sites provide locations for titanate.

When there is more barium than strontium at the A lattice sites in a BST thin-film lattice structure, the lattice becomes more elongated, for example, as illustrated in FIG. 4b. When there are more equal numbers of barium and strontium atoms at the A lattice sites in a BST thin-film lattice structure, the lattice is more cubic, for example as illustrated in FIG. 4c. However, as previously mentioned, achieving a perfect or near perfect stoichiometric lattice structure is extremely difficult if not impossible using conventional methods such as physical vapor deposition.

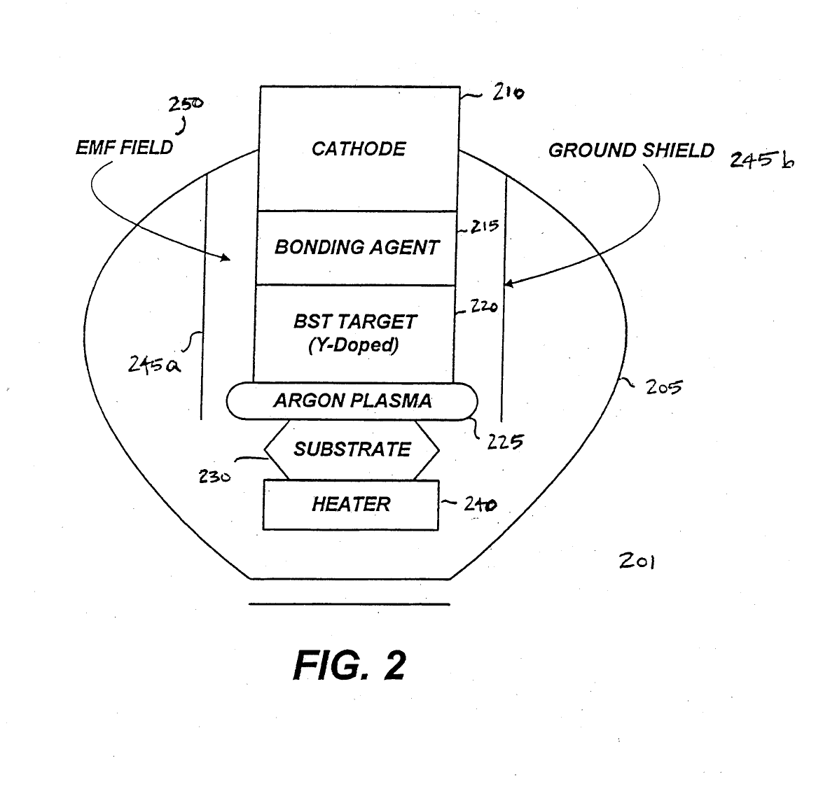

FIG. 2 illustrates an apparatus 201 for BST thin-film growth in accordance with one embodiment of the present invention that utilizes physical vapor deposition. The apparatus 201 includes a vacuum chamber 205 with ground shields 245a, 245b. Between the ground shields 245a, 245b are a cathode 210, a bonding agent 215, a BST target 220, argon plasma 225, a substrate upon which the Y-doped BST thin film is to be grown 230, and a heater 240. Within the chamber 205, components are ordered with the cathode 210 on top followed by the bonding agent 215, the BST target 220, the argon plasma 225, the substrate 230, and the heater 240. Of course, the term “top” is used herein to indicate a relative direction since the chamber may be positioned in any convenient orientation. In one embodiment, the heater 240 is approximately 1 to 2.5 inches from the BST target 220.

In one embodiment, the cathode 210 is comprised of a conductive material, for example, copper, stainless steel, or like material. The bonding agent 215 is comprised of a silver epoxy, indium, or like material. The BST target 220 comprises a yttrium oxide (“Y₂O₃”) dopant in a BST host material. It is noted that the Y₂ 0₃-doped BST target 220 may have 0.10% to 10% yttrium and could also contain other materials and contaminants, as convenient or necessary. It is also noted that the 0.10% to 10% yttrium may be by weight, atomic percentages, mole percentages, or other appropriate ratio.

The argon plasma 225 may be an activated argon gas, e.g., Ar. In one embodiment, the chamber is maintained at 20 milliTorr to 50 milliTorr of Ar and a flow rate of 1 to 200 sccm. It is noted that in one embodiment, the argon gas flows through the chamber. The argon gas may contain oxygen at a ratio of, for example, 1 to 20 or 20 to 1. It is noted that the argon plasma may be confined to an area within the ground shields 245a, 245b in magnetron mode or alternatively could be throughout the chamber 205 in an RF diode mode.

The substrate 230 may be comprised of an insulating material that can withstand high temperatures for processing. The substrate may be comprised of aluminum oxide (“Al₂O₃”), e.g., sapphire or silicon, glass, quartz, GaAs, LaAlO₃, or MGO, or a combination thereof. The heater 240 is a conventional resistance heater that may be configured to provide heat in excess of 400° Celsius.

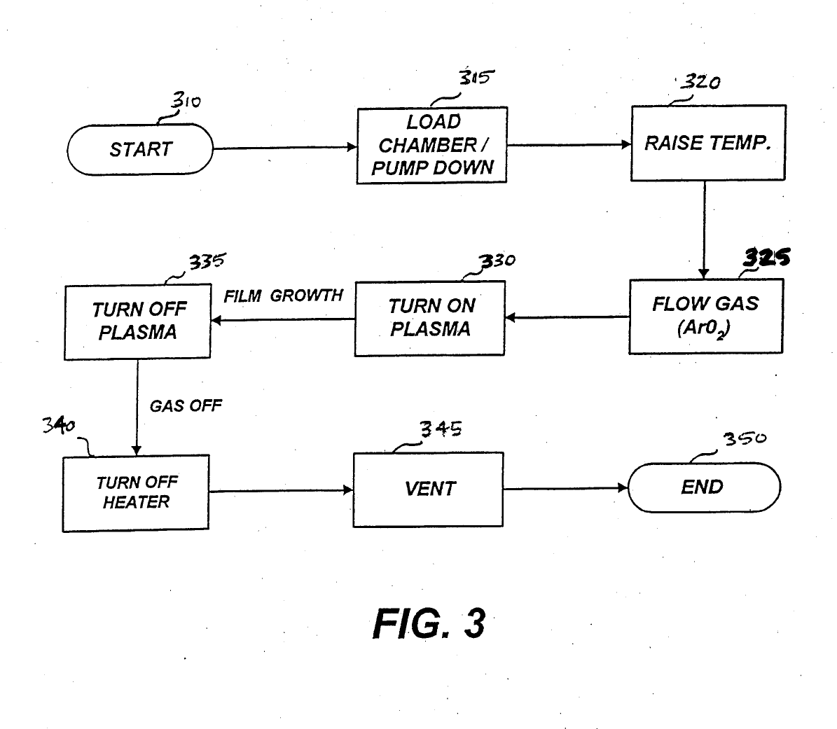

FIG. 3 illustrates a process diagram for BST thin-film growth in the apparatus 201 of FIG. 2 in accordance with one embodiment of the present invention. The process starts 310 by loading 315 the chamber 205 with the various elements, apparatus and materials mentioned above. The chamber pressure may be at atmospheric pressure or may be pumped down to between 10 milliTorr and 60 milliTorr. Pressure in the chamber 205 is preferably pumped down to a vacuum of 10⁻⁵ Torr to 10⁻¹⁰ Torr. The temperature is raised by turning on the heater 240 so that the temperature in the chamber 205 ultimately exceeds 400° Celsius. Further, in one embodiment an appropriate temperature may be determined in terms of having the body in the chamber achieve a red glow, for example, at approximately 600° Celsius.

The flow 325 of argon and oxygen gas is started and then the plasma is turned on 330 by applying RF power to it. For example, in RF diode mode, 100 to 500 Watts is applied to an 8″ diameter yttrium oxide doped BST target 220. It is noted that the plasma power may be ramped up gradually when power is supplied or may be immediately spiked (steep ramp) when power is supplied. It is also noted that the argon and oxygen gas may start flowing prior to or at the time the temperature is being raised. With the plasma energized 330, the growth of the thin-film on the substrate begins. In addition, the process may also be applied in magnetron mode.

Once the thin-film growth is completed, RF power to the plasma is turned off 335 and the flow of argon and oxygen gas is turned off. The heater 240 is turned off 340 and the chamber 205 is vented 350. The chamber may be vented to atmospheric pressure gradually or immediately. It is noted that the cathode 210 can be cooled to remove heat from the BST target to maintain bond stability. This may be done either while the plasma is turned on or after the plasma is turned off. The flow of argon and oxygen gas may be turned off after the plasma is turned off, while the heater is being turned off, or after the heater is turned off. With the process completed, a thin-film growth remains on the substrate 230. Using this method, thin films of, for example, 10 Å to 250 m thick are achievable.

The present invention beneficially promotes stoichiometric BST thin-film growth. More particularly, the addition of yttrium to the BST target 220 (as a Y₂O₃ dopant) helps promote stoichiometric growth because the yttrium can be incorporated into an A lattice site or a B lattice site in the thin-film structure. Further, the use of a yttrium dopant to promote stoiciometric growth of the BST thin-film on the substrate 230 results in increased film resistivity and lower losses, and reduces leakage current. These are generally desirable characteristics for dielectric materials in applications such as capacitors.

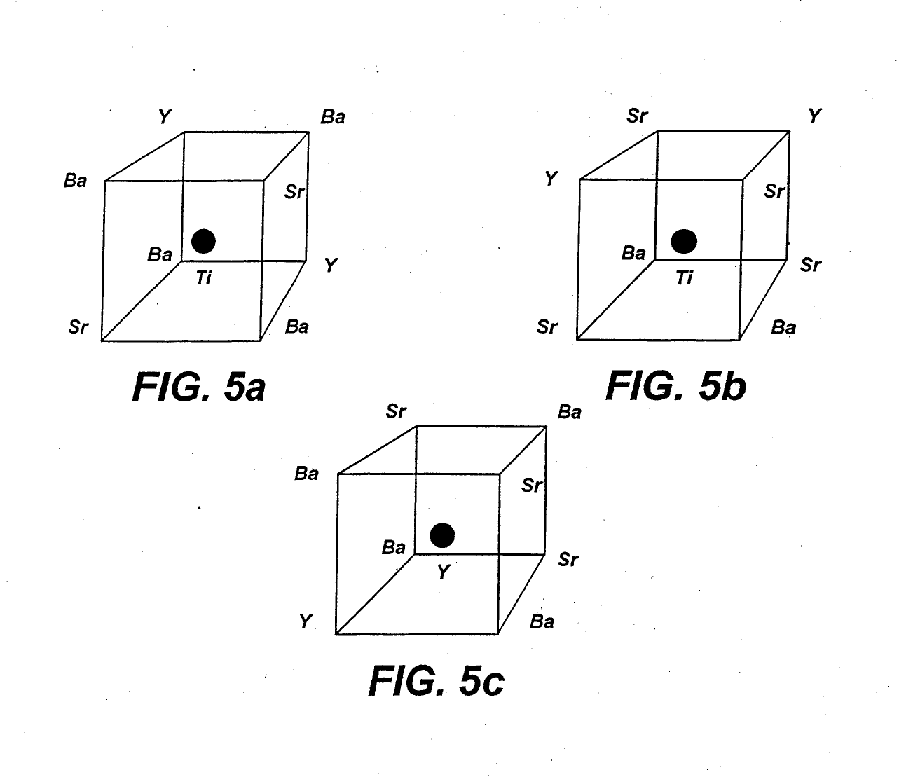

FIGS. 5a through 5c illustrate hypothetical examples of crystal structures for ABO₃ thin-films grown using a Y₂O₃ doped BST target material in accordance with one embodiment of the present invention. In FIGS. 5a and 5b, the yttrium (“Y”) is shown at an A lattice site location, for example, where barium (“Br”) or strontium (“Sr”) normally may be found. FIG. 5c illustrates the yttrium located at the B lattice site location, for example, where the titanium (“Ti”) normally may be found.

The present invention includes a process for influencing the location in the lattice structure where yttrium preferentially compensates for defects in the lattice structure by using a barium and strontium to titanate ratio that can be described, as follows: when ((Ba+Sr)/Ti)>1 there is a tendency for the yttrium to fill the lattice site location of titanate; when ((Ba+Sr)/Ti)<1 there is a tendency for the yttrium to fill the lattice site locations of either the barium or strontium. In one embodiment, an effect of these tendencies allows for locating Y at a Ba, Sr, or Ti site as illustrated in FIGS. 5a through 5c.

An advantage of a process in accordance with the present invention is that the use of yttrium makes the lattice structure less susceptible to the adverse effects of the defect compensation mechanisms and non-stoichiometric ratios of Ba (and/or Sr) to Ti in the lattice structure that may result from the physical vapor deposition process described above. Moreover, it is noted that the principles of the present invention apply to BST thin films in general and processes for making them, including sputtering techniques, physical vapor deposition, and chemical vapor deposition.

Upon reading this disclosure, those of skill in the art will appreciate still additional alternative structural and functional designs for growth of doped and un-doped BST thin films in accordance with the disclosed principles of the present invention. Thus, while particular embodiments and applications of the present invention have been illustrated and described, it is to be understood that the invention is not limited to the precise construction and components disclosed herein. Various modifications (including the use of materials other than BST and Y), which will be apparent to those skilled in the art, may be made in the arrangement, operation and details of the method, materials, apparatus and devices of the present invention without departing from the spirit and scope of the invention as defined in the appended claims and equivalents thereof.

What is claimed is:

1. A thin-film of Y-doped barium strontium titanate (“BST”), comprising:
a plurality of A lattice sites and B lattice sites, the plurality of A lattice sites comprising locations for at least one from a group consisting of barium and strontium and the B lattice sites comprising locations for titanium; and
at least one yttrium atom of the Y-dopant located in at least one of the A lattice sites or the B lattice sites.

2. The thin-film BST of claim 1, wherein the yttrium atoms are preferentially located at the B lattice sites in response to the ratio of ((Ba+Sr)/Ti)<1.

3. The thin-film BST of claim 1, wherein the yttrium atoms are preferentially located at the A lattice sites in response to the ratio of ((Ba+Sr)/Ti)>1.

4. The thin-film BST of claim 1, further comprising a substrate for the thin film of Y-doped BST, wherein the substrate comprises Al₂O₃

5. The thin-film BST of claim 4, wherein the substrate comprises sapphire

6. The thin-film BST of claim 1, wherein the BST thin-film is derived from a yttrium oxide doped BST target.

7. A voltage variable capacitor, comprising:
first and second conductors; and
a Y-doped BST dielectric between the first and second conductors.

8. The voltage variable capacitor of claim 7, wherein the dielectric is a thin film dielectric.

9. The voltage variable capacitor of claim 8, wherein the dielectric is less than 50 microns thick.

10. The voltage variable capacitor of claim 9, wherein the Y-doped BST dielectric has between 0.10% and 10% Y by atomic weight.

11. The voltage variable capacitor of claim 9, wherein Y-doped BST dielectric has between 80% and 120% Ti by atomic weight.
